(19) United States
(12) Patent Application Publication
(10) Pub. No.: US 2025/0104282 A1
(43) Pub. Date: Mar. 27, 2025

(54) IMAGE SUBSAMPLING METHOD AND APPARATUS

(71) Applicant: Beijing Zitiao Network Technology Co., Ltd., Beijing (CN)

(72) Inventor: Shoubo LAI, Beijing (CN)

(21) Appl. No.: 18/725,720

(22) PCT Filed: Dec. 26, 2022
(86) PCT No.: PCT/CN2022/142043

§ 371 Date: Jun. 28, 2024

(30) Foreign Application Priority Data
Dec. 31, 2021 (CN) 202111667403.8

(51) Int. Cl. G06T 7/90; G06T 3/4007; G06T 5/70

(52) U.S. Cl. CPC G06T 7/90; G06T 3/4007; G06T 5/70; G06T 2207/10024

(57) ABSTRACT

An image subsampling method and an apparatus, which relate to the technical field of image processing. The method comprises: acquiring a target image and a subsampling rate; determining a subsampling interval to which the subsampling rate belongs; when the subsampling rate belongs to a first subsampling interval, performing subsampling on the target image by using a first subsampling algorithm; and when the subsampling rate belongs to a second subsampling interval, performing subsampling on the target image by using a second subsampling algorithm; the second subsampling interval is greater than the first subsampling interval; the performance overhead of the second subsampling algorithm is greater than the performance overhead of the first subsampling algorithm; and at an identical subsampling rate, the image quality of a subsampled image obtained by the second subsampling algorithm is higher than the image quality of a subsampled image obtained by the first subsampling algorithm.

### CROSS-REFERENCE TO RELATED APPLICATIONS

This application claims priority to and is based on a Chinese application with an application No. 202111667403.8 and a filing date of Dec. 31, 2021, the aforementioned application is hereby incorporated by reference in its entirety.

### FIELD OF THE INVENTION

The present disclosure relates to image processing technology field, especially relates to an image subsampling method and apparatus.

### BACKGROUND

Image subsampling, also known as image down-sampling, belongs to a technique for reducing the size of an image. In scenarios where images need to be used, there is often a need to reduce a target image to an image with a preset size, such as reduce the image to a size of a preset display region, generate a thumbnail of the image, and so on, therefore, image subsampling is a common image processing problem.

### DISCLOSURE OF THE INVENTION

The present disclosure provides an image subsampling method and apparatus.

The technical solution provided by embodiments of the present disclosure is as follows:

In a first aspect, an embodiment of the present disclosure provides an image subsampling method, including:
acquiring a target image and a subsampling rate for the target image;
determining a subsampling interval to which the subsampling rate belongs;
in response to the subsampling rate belonging to a first subsampling interval, subsampling the target image by using a first subsampling algorithm to obtain a subsampled image from the target image;
in response to the subsampling rate belonging to a second subsampling interval, subsampling the target image by using a second subsampling algorithm to obtain a subsampled image from the target image;

Among them, the second subsampling interval is larger than the first subsampling interval; the performance overhead of the second subsampling algorithm is larger than the performance overhead of the first subsampling algorithm; in response to the subsampling rates being the same, the image quality of the subsampled image obtained by the second subsampling algorithm is better than the image quality of the subsampled image obtained by the first subsampling algorithm.

As an alternative implementation of the embodiment of the present disclosure, the subsampling the target image by using a first subsampling algorithm to obtain a subsampled image from the target image includes: subsampling the target image using a linear interpolation algorithm to obtain a color value of each sampling point; generating a subsampled image from the target image based on the color values of sampling points;
the subsampling the target image by using a second subsampling algorithm to obtain a subsampled image from the target image includes: rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points.

As an alternative implementation of the embodiment of the present disclosure, the subsampling the target image by using a first subsampling algorithm to obtain a subsampled image from the target image includes: subsampling the target image using a linear interpolation algorithm to obtain a color value of each sampling point; generating a subsampled image from the target image based on the color values of sampling points;
the subsampling the target image by using a second subsampling algorithm to obtain a subsampled image from the target image includes: rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

As an alternative implementation of the embodiment of the present disclosure, the subsampling the target image by using a first subsampling algorithm to obtain a subsampled image from the target image includes: rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points;
the subsampling the target image by using a second subsampling algorithm to obtain a subsampled image from the target image includes: rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

As an alternative implementation of the embodiment of the present disclosure, after generating a subsampled image from the target image based on the color values of sampling points, the method includes:
calculating a first calculated value for each pixel in the subsampled image, wherein the first calculated value for any pixel is an average value of color values of preset neighborhood pixels of the pixel;
calculating a second calculated value for each pixel in the subsampled image, wherein the second calculated value for any pixel is a difference between the color value of the pixel and the first calculated value for the pixel;
calculating a third calculated value for each pixel in the subsampled image, wherein the third calculated value for any pixel is a product of the second calculated value for the pixel and a sharpening coefficient;
calculating a sharpened color value corresponding to each pixel in the subsampled image, wherein the sharpened color value corresponding to any pixel is the sum of the color value of the pixel and the third calculated value for the pixel.

As an alternative implementation of the embodiment of the present disclosure, the method further includes:
in response to the sharpened color value corresponding to the first pixel in the subsampled image being greater than a maximum color value of a color space to which the subsampled image belongs, setting the sharpened color value corresponding to the first pixel to the maximum color value;
in response to the sharpened color value corresponding to the second pixel in the subsampled image being less than a minimum color value of the color space to which the subsampled image belongs, setting the sharpened color value corresponding to the second pixel to the minimum color value.

In a second aspect, an embodiment of the present disclosure provides an image subsampling apparatus, including:
an acquisition unit configured to acquire a target image and a subsampling rate for the target image;
a determination unit configured to determine a subsampling interval to which the subsampling rate belongs;
a subsampling unit configured to, in response to the subsampling rate belonging to a first subsampling interval, subsample the target image by using a first subsampling algorithm to obtain a subsampled image from the target image; in response to the subsampling rate belonging to a second subsampling interval, subsample the target image by using a second subsampling algorithm to obtain a subsampled image from the target image;

Among them, the second subsampling interval is larger than the first subsampling interval; the performance overhead of the second subsampling algorithm is larger than the performance overhead of the first subsampling algorithm; in response to the subsampling rates being the same, the image quality of the subsampled image obtained by the second subsampling algorithm is better than the image quality of the subsampled image obtained by the first subsampling algorithm.

As an alternative implementation of an embodiment of the present disclosure, the subsampling unit is specifically configured to, in response to the subsampling rate belonging to the first subsampling interval, subsample the target image using a linear interpolation algorithm to obtain a color value of each sampling point; generate a subsampled image from the target image based on the color values of sampling points; in response to the subsampling rate belonging to the second subsampling interval, render image data of the target image into a preset texture object to obtain a target render texture; the size of the preset texture object is the same as the size of the target image; subsample the target render texture using a regional average interpolation algorithm to obtain a color value of each sampling point; and generate a subsampled image from the target image based on the color values of sampling points.

As an alternative implementation of an embodiment of the present disclosure, the subsampling unit is specifically configured to, in response to the subsampling rate belonging to the first subsampling interval, subsample the target image using a linear interpolation algorithm to obtain a color value of each sampling point; generate a subsampled image from the target image based on the color values of sampling points; in response to the subsampling rate belonging to the second subsampling interval, render image data of the target image into a preset texture object to obtain a target render texture; the size of the preset texture object is the same as the size of the target image; subsample the target render texture using a window function algorithm to obtain a color value of each sampling point; and generate a subsampled image from the target image based on the color values of sampling points.

As an alternative implementation of an embodiment of the present disclosure, the subsampling unit is specifically configured to, in response to the subsampling rate belonging to the first subsampling interval, render image data of the target image into a preset texture object to obtain a target render texture; the size of the preset texture object is the same as the size of the target image; subsample the target render texture using a regional average interpolation algorithm to obtain a color value of each sampling point; and generate a subsampled image from the target image based on the color values of sampling points; in response to the subsampling rate belonging to the second subsampling interval, render image data of the target image into a preset texture object to obtain a target render texture; the size of the preset texture object is the same as the size of the target image; subsample the target render texture using a window function algorithm to obtain a color value of each sampling point; and generate a subsampled image from the target image based on the color values of sampling points.

As an alternative implementation of the embodiment of the present disclosure, the image subsampling apparatus may also include: a sharpening unit configured to, after the subsampling unit generates a subsampled image from the target image based on the color values of sampling points, calculate a first calculated value for each pixel in the subsampled image, wherein the first calculated value for any pixel is an average value of color values of preset neighborhood pixels of the pixel; calculate a second calculated value for each pixel in the subsampled image, wherein the second calculated value for any pixel is a difference between the color value of the pixel and the first calculated value for the pixel; calculate a third calculated value for each pixel in the subsampled image, wherein the third calculated value for any pixel is a product of the second calculated value for the pixel and a sharpening coefficient; calculate a sharpened color value corresponding to each pixel in the subsampled image, wherein the sharpened color value corresponding to any pixel is the sum of the color value of the pixel and the third calculated value for the pixel.

As an alternative implementation of an embodiment of the present disclosure, the sharpening unit is further configured to, in response to the sharpened color value corresponding to the first pixel in the subsampled image being greater than a maximum color value of a color space to which the subsampled image belongs, set the sharpened color value corresponding to the first pixel to the maximum color value; in response to the sharpened color value corresponding to the second pixel in the subsampled image being less than a minimum color value of the color space to which the subsampled image belongs, set the sharpened color value corresponding to the second pixel to the minimum color value.

In a third aspect, an embodiment of the present disclosure provides an electronic device, comprising: a memory and a processor, wherein the memory is used to store a computer program; and the processor is used to, when calling the computer program, enable the electronic device to implement the image subsampling method described in the first aspect or any alternative implementation of the first aspect.

In a fourth aspect, an embodiment of the present disclosure provides a computer-readable storage medium, wherein a computer program, when executed by a computing device, enables the computing device to implement the image subsampling method described in the first aspect or any alternative implementation of the first aspect.

In a fifth aspect, an embodiment of the present disclosure provides a computer program product which, when running on a computer, enables the computer to implement the image subsampling method described in the first aspect or any alternative implementation of the first aspect.

### DESCRIPTION OF THE DRAWINGS

The accompanying drawings, which are incorporated in and constitute a part of this specification, illustrate embodiments consistent with the disclosure and together with the description, serve to explain the principles of the disclosure.

In order to more clearly explain the technical scheme in the embodiment of the present disclosure or the related technology, the drawings needed in the description of the embodiments or the prior art will be briefly introduced below, obviously, for those ordinary skilled in the art, other drawings can be obtained according to these drawings without paying creative labor.

FIG. 1 is a first one of step flowchart diagrams for the image subsampling method provided by an embodiment of the present disclosure;

FIG. 2 is a second one of step flowchart diagrams for the image subsampling method provided by an embodiment of the present disclosure;

FIG. 3 is a schematic diagram of preset neighborhood pixels provided by an embodiment of the present disclosure;

FIG. 4 is a first one of schematic diagrams for the image subsampling apparatus provided by an embodiment of the present disclosure;

FIG. 5 is a second one of schematic diagrams for the image subsampling apparatus provided by an embodiment of the present disclosure;

FIG. 6 is a hardware structure schematic diagram for an electronic device provided by an embodiment of the present disclosure.

### DETAILED DESCRIPTION OF PREFERRED EMBODIMENTS

In order to be more clearly understood the above object, features and advantages of the present application, the schemes of the present application will be further described hereinafter. It should be noted that embodiments and features in the embodiments of the present application can be combined with each other without conflict.

Many specific details are set forth in the following description to facilitate a thorough understanding of the present application, but the present application may also be practiced in other manners than that described herein; obviously, the embodiments in the specification are only part of, instead of all, embodiments of the present application.

It should be noted that, in order to facilitate a clear description of the technical solutions of the embodiments of the present disclosure, in the embodiments of the present disclosure, words such as “first” and “second” are used to distinguish between identical items or similar items with basically same functions and effects, those skilled in the art can understand that words such as “first” and “second” do not limit the quantity and execution order. For example, the first feature image set and the second feature image set are only used to distinguish different feature image sets, rather than to limit the order of the feature image sets.

In embodiments of the present disclosure, words such as “exemplary” or “for example” are used to indicate examples, instances or illustrations. Any embodiment or design described as “exemplary” or “for example” in the embodiments of the present disclosure should not be construed as being more preferred or advantageous over other embodiments or designs, more exactly, the use of words such as “exemplary” or “such as” are intended to present the relevant concepts in a concrete fashion. Furthermore, in the description of the embodiments of the present disclosure, unless otherwise specified, “plurality” means two or more.

The current image subsampling algorithms find it difficult to balance the image quality of the subsampled image with the performance overhead of the device that implements the image subsampling. Therefore, how to reduce the performance overhead of image subsampling while ensuring the image quality of the subsampled image is an issue that needs to be continuously explored.

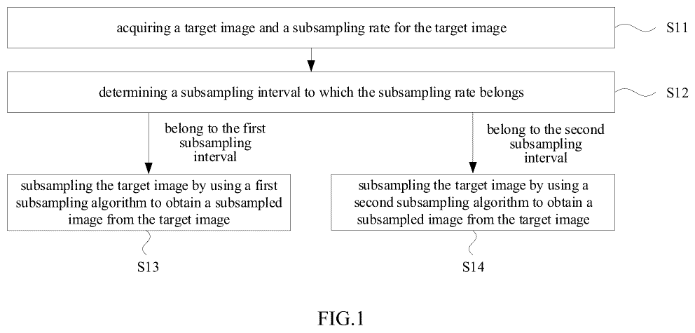

Based on the above content, an embodiment of the present disclosure provides an image subsampling method. As shown in FIG. 1, the image subsampling method provided by the embodiment of the present disclosure includes the following steps:

S11. Acquiring a target image and a subsampling rate for the target image.

Optionally, an implementation for acquiring a target image and a subsampling rate for the target image may include: upon receipt of a user input for adding a target image to a preset display region, acquiring a size of the target image and a size of the preset display region, and calculate the subsampling rate for the target image based on the size of the target image and the size of the preset display region. For example, if the size of the target image is H*W and the size of the preset display region is H/4*W/4, then the subsampling rate for the target image is determined to be 4.

Optionally, an implementation for acquiring a target image and a subsampling rate for the target image may also include: upon receipt of a user input for sending the target image, acquiring a size of the target image and a size of a thumbnail of the target image, and calculate the subsampling rate for the target image based on the size of the target image and the size of the thumbnail. For example, if the size of the target image is H*W and the size of the thumbnail of the target image is H/16*W/16, then the subsampling rate for the target image is determined to be 16.

S12: determining a subsampling interval to which the subsampling rate belongs.

Among them, the subsampling interval may include: a first subsampling interval and a second subsampling interval, and the second subsampling interval is larger than the first subsampling interval.

Specifically, in the embodiment of the present disclosure, a subsampling range (1, +∞) is divided into two subsampling intervals (a first subsampling interval and a second subsampling interval) with sequentially increasing sampling rates in advance. Exemplarily, the first subsampling interval may be (1, 8), and the second subsampling interval may be [8, +∞].

In the above step S12, if the subsampling rate belongs to the first subsampling interval, the following step S13 is executed.

S13. subsampling the target image using a first subsampling algorithm to obtain a subsampled image from the target image.

In the above step S12, if the subsampling rate belongs to the second subsampling interval, the following step S14 is executed.

S14. subsampling the target image using a second subsampling algorithm to obtain a subsampled image from the target image.

Among them, the second subsampling interval is larger than the first subsampling interval; the performance overhead of the second subsampling algorithm is larger than the performance overhead of the first subsampling algorithm; under the same subsampling rate, the image quality of the subsampled image obtained by the second subsampling algorithm is better than the image quality of the subsampled image obtained by the first subsampling algorithm.

The first subsampling algorithm and the second subsampling algorithm in the above embodiment will be described below.

In some embodiments, the implementations of the above step S13 and step S14 may respectively include:

The above step S13 (subsampling the target image using a first subsampling algorithm to obtain a subsampled image from the target image) may include:
subsampling the target image using a linear interpolation algorithm to obtain a color value of each sampling point; generating a subsampled image from the target image based on the color values of sampling points.

The above step S14 (subsampling the target image using a second subsampling algorithm to obtain a subsampled image from the target image) may include:
rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points.

In some other embodiments, the implementations of the above step S13 and step S14 may respectively include:

The above step S13 (subsampling the target image using a first subsampling algorithm to obtain a subsampled image from the target image) may include:
subsampling the target image using a linear interpolation algorithm to obtain a color value of each sampling point; generating a subsampled image from the target image based on the color values of sampling points.

The above step S14 (subsampling the target image using a second subsampling algorithm to obtain a subsampled image from the target image) may include:
rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

In still some other embodiments, the implementations of the above step S13 and step S14 may respectively include:

The above step S13 (subsampling the target image using a first subsampling algorithm to obtain a subsampled image from the target image) includes:
rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points.

The above step S14 (subsampling the target image using a second subsampling algorithm to obtain a subsampled image from the target image) may include:
rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

For subsampling the target image, the image subsampling method provided by the embodiment of the present disclosure first determines the subsampling interval to which the subsampling rate for the target image belongs, then, in response tothe subsampling rate belongs to the first subsampling interval, subsample the target image by using a first subsampling algorithm to obtain the subsampled image from the target image, in response to the subsampling rate belonging to a second subsampling interval, subsample the target image by using a second subsampling algorithm to obtain a subsampled image from the target image. Since the larger the subsampling rate is, the weaker the image quality of the subsampled image obtained by the same sampling algorithm is, the embodiment of the present disclosure uses the first subsampling algorithm with relatively low performance overhead to subsample the target image to obtain the subsampled image from the target image when the subsampling rate belongs to the first subsampling interval (the subsampling rate is relatively small), thereby saving the performance overhead of image subsampling; and uses the second subsampling algorithm, with which the image quality of the subsampled image obtained by image subsampling is best, to subsample the target image to obtain the subsampled image from the target image, when the subsampling rate belongs to the second subsampling interval (the subsampling rate is relatively large), thereby improving the image quality of the subsampled image obtained by subsampling the target image. Since the embodiment of the present disclosure can use corresponding sampling algorithms for different subsampling rates to subsample the target image, the embodiment of the present disclosure can reduce the performance overhead of image subsampling while ensuring the image quality of the subsampled image.

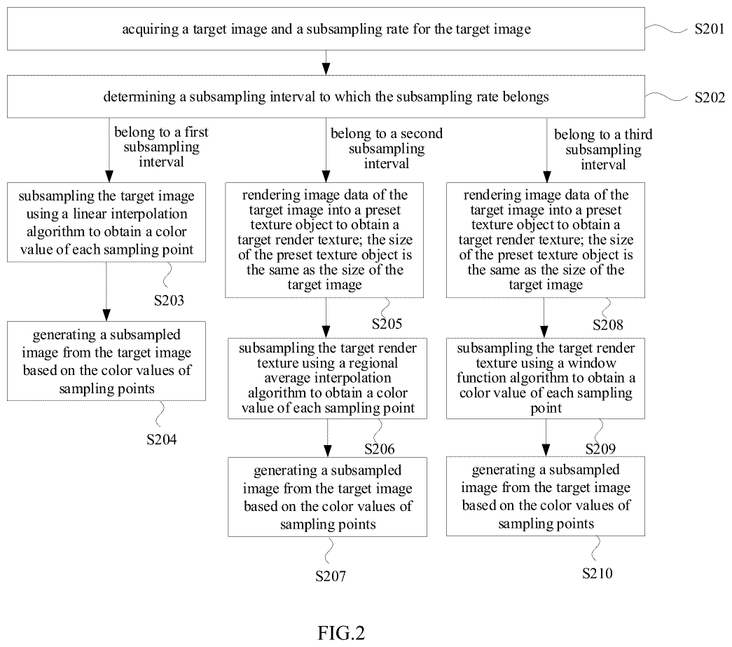

As an extension and refinement of the above embodiment, an embodiment of the present disclosure provides another image subsampling method. As shown in FIG. 2, the image subsampling method may include the following steps:

S201. acquiring a target image and a subsampling rate for the target image.

The implementation of step S201 in the embodiment of the present disclosure may be the same as the implementation of step S11 as described above, and will not be described in detail herein.

S202: determining a subsampling interval to which the subsampling rate belongs.

Among them, the subsampling interval may include: a first subsampling interval, a second subsampling interval, and a third subsampling interval, and the sampling rates in the first subsampling interval, the second subsampling interval and the third subsampling interval increase sequentially.

Exemplarily, in the embodiment of the present disclosure, the subsampling range (1, +∞) can be divided into three subsampling intervals (a first subsampling interval, a second subsampling interval, and a third subsampling interval) with sequentially increasing sampling rates in advance. Exemplarily, the first subsampling interval may be (1, 2), the second subsampling interval may be [2, 8), and the third subsampling interval may be [8, +∞).

In the above step S202, if the subsampling rate belongs to the first subsampling interval, the following steps S203 and S204 can be executed.

S203: subsample the target image using a linear interpolation algorithm to obtain a color value of each sampling point.

Optionally, the linear interpolation algorithm in the embodiment of the present disclosure may include nearest neighbor interpolation, bilinear interpolation, or bicubic interpolation.

When the target image is subsampled using the nearest neighbor interpolation, for each sampling point, the color value of one of four adjacent pixels around the sampling point, which is closest to the sampling point, can be obtained as the color value of each sampling point.

When the target image is subsampled using the bilinear interpolation, for each sampling point, a color value can be obtained by interpolating the color values of four adjacent pixels around the sampling point in two directions, and serves as the color value of the sampling point.

When the target image is subsampled using the trilinear interpolation, the color value of each sampling point can be determined based on the color values of four adjacent pixels around the sampling point and the rate of change of the color values among the adjacent pixels.

S204: generating a subsampled image from the target image based on the color values of sampling points.

That is, each sampling point is used as a pixel in the subsampled image from the target image, thereby generating a subsampled image from the target image.

In the above step S202, if the subsampling rate belongs to the second subsampling interval, the following steps S205 to S207 can be executed.

S205: rendering image data of the target image into a preset texture object to obtain a target render texture.

Among them, the size of the preset texture object is the same as the size of the target image.

Optionally, the preset texture object may be a texture object under a RGBA color standard. That is, each pixel of the preset texture object can include four color components, namely: red component (R), green component (G), blue component (B) and alpha component, wherein the alpha component is used to characterize opacity, when alpha=1, the transparency is 0%, when alpha=0, the transparency is 100%.

S206: subsampling the target render texture using a regional average interpolation algorithm to obtain a color value of each sampling point.

Specifically, the regional average interpolation algorithm may be a special form of the window function algorithm, and the color value of each sampling point can be the linear average of color values of all pixels in a two-dimensional window of subsampling rate.

S207: generating a subsampled image from the target image based on the color values of sampling points.

In the above step S202, if the subsampling rate belongs to the third subsampling interval, the following steps S208 to S210 will be executed.

S208: rendering image data of the target image into a preset texture object to obtain a target render texture.

Wherein, the size of the preset texture object is the same as the size of the target image.

Likewise, the preset texture object may be a texture object under the RGBA color standard.

S209: subsampling the target render texture using a window function algorithm to obtain a color value of each sampling point.

Specifically, the window function algorithm can be a FIR low-pass filter designed for setting a specified subsampling rate as a cutoff frequency from the perspective of digital signal processing, the window may optionally include 4×4, 8×8, 16×16, 24×24, etc., the envelope function may be, for example, Lanczos, Hamming, Kaiser, etc., and the kernel function is Sinc.

Exemplarily, in the window function algorithm in embodiments of the present disclosure, the window is 8×8, and the envelope function is Kaiser.

S210: generating a subsampled image from the target image based on the color values of sampling points.

For subsampling the target image, the image subsampling method provided by the embodiment of the present disclosure first determines the subsampling interval to which the subsampling rate for the target image belongs, then, in response to the subsampling rate belonging to the first subsampling interval, subsample the target image by using a first subsampling algorithm to obtain the subsampled image from the target image, in response to the subsampling rate belonging to a second subsampling interval, subsample the target image by using a second subsampling algorithm to obtain a subsampled image from the target image, and in response to the subsampling rate belonging to a third subsampling interval, subsample the target image by using a third subsampling algorithm to obtain a subsampled image from the target image. Given the larger the subsampling rate is, the weaker the image quality of the subsampled image obtained by the same sampling algorithm is, the embodiment of the present disclosure uses the first subsampling algorithm with relatively low performance overhead to subsample the target image to obtain the subsampled image from the target image when the subsampling rate belongs to the first subsampling interval (the subsampling rate is relatively small), thereby saving the performance overhead of image subsampling; uses the second subsampling algorithm which is balanced between the performance overhead and the image quality to subsample the target image to obtain the subsampled image from the target image, when the subsampling rate belongs to the second subsampling interval (the subsampling rate is moderate), thereby balancing the performance overhead of image subsampling and the image intensity of the subsampled image obtained by image subsampling, and uses the third subsampling algorithm, with which the image quality of the subsampled image obtained by image subsampling is best, to subsample the target image to obtain the subsampled image of the target image, when the subsampling rate belongs to the third subsampling interval (the subsampling rate is relatively large), thereby improving the image quality of the subsampled image obtained by subsampling the target image. Since the embodiment of the present disclosure can use corresponding sampling algorithms for different subsampling rates to subsample the target image, the embodiment of the present disclosure can reduce the performance overhead of image subsampling while ensuring the image quality of the subsampled image.

As an alternative implementation of the embodiment of the present disclosure, after generating a subsampled image from the target image based on the color values of sampling points, the image subsampling method provided by the embodiment of the present disclosure can further includes the following steps a to d:

Step a: calculating a first calculated value for each pixel in the subsampled image.

Wherein, the first calculated value for any pixel is an average value of color values of preset neighborhood pixels of the pixel.

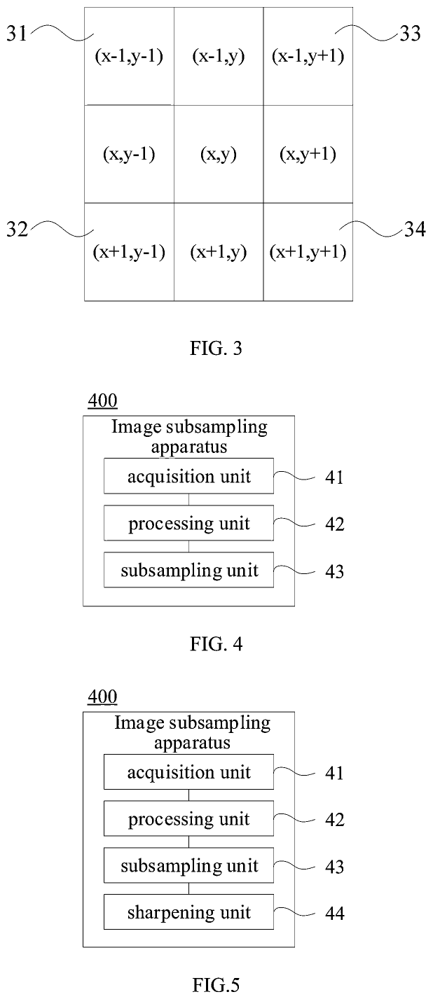

Exemplarily, as shown in FIG. 3, the preset neighborhood pixels of any pixel may include: a pixel 31 at the upper right adjacent to the pixel, a pixel 32 at the lower right adjacent to the pixel, a pixel 33 at the upper left adjacent to the pixel, and a pixel 34 at the lower left adjacent to the pixel.

Assume that the first calculated value for the pixel (x, y) in the subsampled image is C1, then:

$${C}_{1} = [ {P}_{( x + 1 , y )} + {P}_{( x - 1 , y )} + {P}_{( x , y + 1 )} + {P}_{( x , y - 1 )} ] / 4$$

Among them, P_{(x+1, y)}, P_{(x-1, y)}, P_{(x, y+1)}, P_{(x, y-1)} are the color value of each preset neighborhood pixel respectively.

Step b: calculating a second calculated value for each pixel in the subsampled image.

Wherein, the second calculated value for any pixel is a difference between the color value of the pixel and the first calculated value for the pixel.

Assume that the second calculated value for the pixel (x, y) in the subsampled image is C₂, then:

$${C}_{2} = {P}_{( x , y )} - {C}_{1}$$

Among them, P_{(x, y)} is the color value of the pixel (x, y) in the subsampled image.

Step c: calculating a third calculated value for each pixel in the subsampled image.

Wherein, the third calculated value for any pixel is a product of the second calculated value for the pixel and a sharpening coefficient.

Assume that the third calculated value for the pixel (x, y) in the subsampled image is C₃, then:

$${C}_{3} = k * {C}_{2}$$

Step d: calculating a sharpened color value corresponding to each pixel in the subsampled image.

Wherein, the sharpened color value corresponding to any pixel is the sum of the color value of the pixel and the third calculated value for the pixel.

Assume that the sharpened color value corresponding to the pixel (x, y) in the subsampled image is P′_{(x, y)}, then:

$${P}_{( x , y )}^{′} = {P}_{( x , y )} + {C}_{3}$$

Further optionally, the image subsampling method provided by the embodiment of the present disclosure may further includes:
in response to the sharpened color value corresponding to the first pixel in the subsampled image being greater than a maximum color value of a color space to which the subsampled image belongs, setting the sharpened color value corresponding to the first pixel to the maximum color value;
in response to the sharpened color value corresponding to the second pixel in the subsampled image is less than a minimum color value of the color space to which the subsampled image belongs, setting the sharpened color value corresponding to the second pixel to the minimum color value.

Specifically, the color values in the color space to which the subsampled image belongs may be normalized, when P′_{(x, y)}<0, P′_{(x, y)}=0 is set; and when, P′_{(x, y)}=1 is set.

Since the above embodiment further sets the sharpened color value corresponding to each pixel in the color range of the color space to which the subsampled image belongs, the above embodiment can solve the problem that the color value of the pixel in the subsampled image exceeds the color range of the color space to which the subsampled image belongs, thereby solving the problem that the subsampled image after sharpening cannot be displayed normally.

Based on the same inventive concept, as an implementation of the above method, an embodiment of the present disclosure further proposes an image subsampling apparatus, and the apparatus embodiment corresponds to the above method embodiment, for ease of reading, the present apparatus embodiment will no longer repeat the details of the above method embodiment one by one, but it should be understood that the image subsampling apparatus in the embodiment can correspond to all the contents in the above method embodiments.

An embodiment of the present disclosure provides an image subsampling apparatus. FIG. 4 is a structurally schematic diagram of the of the image subsampling apparatus. As shown in FIG. 4, the image subsampling apparatus 400 may include:
an acquisition unit 41 configured to acquire a target image and a subsampling rate for the target image;
a determination unit 42 configured to determine a subsampling interval to which the subsampling rate belongs;
a subsampling unit 43 configured to, in response to that the subsampling rate belonging to a first subsampling interval, subsample the target image by using a first subsampling algorithm to obtain a subsampled image from the target image; in response to the subsampling rate belonging to a second subsampling interval, subsample the target image by using a second subsampling algorithm to obtain a subsampled image from the target image;

Among them, the second subsampling interval is larger than the first subsampling interval; the performance overhead of the second subsampling algorithm is larger than the performance overhead of the first subsampling algorithm; in response to the subsampling rates being the same, the image quality of the subsampled image obtained by the second subsampling algorithm is better than the image quality of the subsampled image obtained by the first subsampling algorithm.

As an alternative implementation of an embodiment of the present disclosure, the subsampling unit 43 can be specifically configured to, in response to the subsampling rate belongs to the first subsampling interval, subsample the target image using a linear interpolation algorithm to obtain a color value of each sampling point; generate a subsampled image from the target image based on the color values of sampling points; in response to the subsampling rate belonging to the second subsampling interval, render image data of the target image into a preset texture object to obtain a target render texture; the size of the preset texture object is the same as the size of the target image; subsample the target render texture using a regional average interpolation algorithm to obtain a color value of each sampling point; and generate a subsampled image from the target image based on the color values of sampling points.

As an alternative implementation of an embodiment of the present disclosure, the subsampling unit 43 can be specifically configured to, in response to the subsampling rate belonging to the first subsampling interval, subsample the target image using a linear interpolation algorithm to obtain a color value of each sampling point; generate a subsampled image from the target image based on the color values of sampling points; in response to the subsampling rate belonging to the second subsampling interval, render image data of the target image into a preset texture object to obtain a target render texture; the size of the preset texture object is the same as the size of the target image; subsample the target render texture using a window function algorithm to obtain a color value of each sampling point; and generate a subsampled image from the target image based on the color values of sampling points.

As an alternative implementation of an embodiment of the present disclosure, the subsampling unit 43 can be specifically configured to, in response to the subsampling rate belonging to the first subsampling interval, render image data of the target image into a preset texture object to obtain a target render texture; the size of the preset texture object is the same as the size of the target image; subsample the target render texture using a regional average interpolation algorithm to obtain a color value of each sampling point; and generate a subsampled image from the target image based on the color values of sampling points; in response to the subsampling rate belonging to the second subsampling interval, render image data of the target image into a preset texture object to obtain a target render texture; the size of the preset texture object is the same as the size of the target image; subsample the target render texture using a window function algorithm to obtain a color value of each sampling point; and generate a subsampled image from the target image based on the color values of sampling points.

As an alternative implementation of the embodiment of the present disclosure, as shown in FIG. 5, the image subsampling apparatus provide by an embodiment of the present disclosure may also include: a sharpening unit 44 configured to, after the subsampling unit generates a subsampled image from the target image based on the color values of sampling points, calculate a first calculated value for each pixel in the subsampled image, wherein the first calculated value for any pixel is an average value of color values of preset neighborhood pixels of the pixel; calculate a second calculated value for each pixel in the subsampled image, wherein the second calculated value for any pixel is a difference between the color value of the pixel and the first calculated value for the pixel; calculate a third calculated value for each pixel in the subsampled image, wherein the third calculated value for any pixel is a product of the second calculated value for the pixel and a sharpening coefficient; calculate a sharpened color value corresponding to each pixel in the subsampled image, wherein the sharpened color value corresponding to any pixel is the sum of the color value of the pixel and the third calculated value for the pixel.

As an alternative implementation of an embodiment of the present disclosure, the sharpening unit 44 may be further configured to, in response to the sharpened color value corresponding to the first pixel in the subsampled image being greater than a maximum color value of a color space to which the subsampled image belongs, set the sharpened color value corresponding to the first pixel to the maximum color value; in response to the sharpened color value corresponding to the second pixel in the subsampled image being less than a minimum color value of the color space to which the subsampled image belongs, set the sharpened color value corresponding to the second pixel to the minimum color value.

The image subsampling apparatus provided by the embodiment can execute the image subsampling method provided by the above method embodiments, has the similar implementation principle and technical effects, and will not be repeated here.

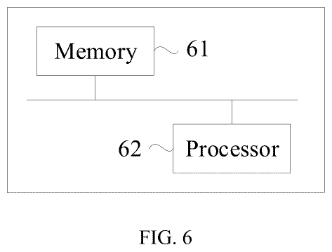

Based on the same inventive concept, an embodiment of the present disclosure further provides an electronic device. FIG. 6 is a structural schematic diagram of an electronic device provided by an embodiment of the present disclosure. As shown in FIG. 6, the electronic device provided by the embodiment may include: a memory 61 and a processor 62, wherein the memory 61 is used to store a computer program; and the processor 62 is used to execute the image subsampling method provided by the above embodiments when calling the computer program.

Based on the same inventive concept, an embodiment of the present disclosure further provides a computer-readable storage medium, on which a computer program is stored, the computer program, when executed by a processor, causes the computing device to implement the image subsampling method provided by the above embodiments.

Based on the same inventive concept, an embodiment of the present disclosure further provides a computer program product, which, when running on a computing device, causes the computing device to implement the image subsampling method provided by the above embodiments.

Those skilled in the art should appreciate that the embodiments of the present disclosure may be embodied as methods, systems, or computer program products. Accordingly, the present disclosure may take the form of an entirely hardware embodiment, an entirely software embodiment, or an embodiment combining software and hardware aspects. Furthermore, the present disclosure may take the form of a computer program product embodied in one or more computer-usable storage mediums having computer-usable program codes contained therein.

The processor can be a central processing unit (CPU), or other general-purpose processors, digital signal processors (DSP), application-specific integrated circuits (ASIC), field-programmable gate arrays (FPGA) or other programmable logic devices, discrete gate or transistor logic devices, discrete hardware components, etc. A general-purpose processor may be a microprocessor, or the processor may be any conventional processor or the like.

The memory may include non-permanent memory, random access memory (RAM) and/or non-volatile memory, etc., such as read-only memory (ROM) or flash RAM. Memory is an example of a computer-readable medium.

Computer readable media may include permanent and non-permanent, removable and non-removable storage media. The storage medium may implement information storage by any method or technology, and the information may be computer-readable instructions, data structures, program units or other data. Examples of computer storage media include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk-read-only memory (CD-ROM), digital versatile disk (DVD) or other optical storage, magnetic cassettes, magnetic disk storage or other magnetic storage devices, or any other non-transmission medium that can be used to store information that can be accessed by a computing device. According to the definition in this article, computer-readable media does not include transitory media, such as modulated data signals and carrier waves.

Finally, it should be noted that the above embodiments are only used to illustrate the technical solutions of the present disclosure, rather than to limit it. Although the present disclosure has been described in detail with reference to the aforementioned embodiments, those skilled in the art should understand that they can still modify the technical solutions described in the aforementioned embodiments, or replace some or all of the technical features therein by equivalents. However, these modifications or replacements do not cause the essence of the corresponding technical solutions to deviate from the scope of the technical solutions of the embodiments of the present disclosure.

1. An image subsampling method, comprising:
acquiring a target image and a subsampling rate for the target image;
determining a subsampling interval to which the subsampling rate belongs;
in response to the subsampling rate belonging to a first subsampling interval, subsampling the target image by using a first subsampling algorithm to obtain a subsampled image from the target image;
in response to the subsampling rate belonging to a second subsampling interval, subsampling the target image by using a second subsampling algorithm to obtain a subsampled image from the target image;
wherein, the second subsampling interval is larger than the first subsampling interval; the performance overhead of the second subsampling algorithm is larger than the performance overhead of the first subsampling algorithm; in response to the subsampling rates being the same, the image quality of the subsampled image obtained by the second subsampling algorithm is better than the image quality of the subsampled image obtained by the first subsampling algorithm.

2. The method of claim 1, wherein,
the subsampling the target image by using a first subsampling algorithm to obtain a subsampled image from the target image, comprises: subsampling the target image using a linear interpolation algorithm to obtain a color value of each sampling point; generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points.

3. The method of claim 1, wherein,
the subsampling the target image by using a first subsampling algorithm to obtain a subsampled image from the target image, comprises: subsampling the target image using a linear interpolation algorithm to obtain a color value of each sampling point; generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

4. The method of claim 1, wherein,
the subsampling the target image by using a first subsampling algorithm to obtain a subsampled image from the target image, comprises: rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

5. The method of claim 2, wherein,
after generating a subsampled image from the target image based on the color values of sampling points, the method further comprises:
calculating a first calculated value for each pixel in the subsampled image, wherein the first calculated value for any pixel is an average value of color values of preset neighborhood pixels of the pixel;
calculating a second calculated value for each pixel in the subsampled image, wherein the second calculated value for any pixel is a difference between the color value of the pixel and the first calculated value for the pixel;
calculating a third calculated value for each pixel in the subsampled image, wherein the third calculated value for any pixel is a product of the second calculated value for the pixel and a sharpening coefficient; and
calculating a sharpened color value corresponding to each pixel in the subsampled image, wherein the sharpened color value corresponding to any pixel is the sum of the color value of the pixel and the third calculated value for the pixel.

6. The method of claim 5, wherein, the method further comprises:
in response to the sharpened color value corresponding to the first pixel in the subsampled image being greater than a maximum color value of a color space to which the subsampled image belongs, setting the sharpened color value corresponding to the first pixel to the maximum color value;
in response to the sharpened color value corresponding to the second pixel in the subsampled image being less than a minimum color value of the color space to which the subsampled image belongs, setting the sharpened color value corresponding to the second pixel to the minimum color value.

7. (canceled)

8. An electronic device comprises: a memory and a processor, wherein the memory is configured to store a computer program; and the processor is configured to, when executing the computer program, enable the electronic device to implement:
acquiring a target image and a subsampling rate for the target image;
determining a subsampling interval to which the subsampling rate belongs;
in response to the subsampling rate belonging to a first subsampling interval, subsampling the target image by using a first subsampling algorithm to obtain a subsampled image from the target image;
in response to the subsampling rate belonging to a second subsampling interval, subsampling the target image by using a second subsampling algorithm to obtain a subsampled image from the target image;
wherein, the second subsampling interval is larger than the first subsampling interval; the performance overhead of the second subsampling algorithm is larger than the performance overhead of the first subsampling algorithm; in response to the subsampling rates being the same, the image quality of the subsampled image obtained by the second subsampling algorithm is better than the image quality of the subsampled image obtained by the first subsampling algorithm.

9. A non-transitory computer-readable storage medium having a computer program stored thereon, wherein the computer program, when executed by a computing device, causes the computing device to implement:
acquiring a target image and a subsampling rate for the target image;
determining a subsampling interval to which the subsampling rate belongs;
in response to the subsampling rate belonging to a first subsampling interval, subsampling the target image by using a first subsampling algorithm to obtain a subsampled image from the target image;
in response to the subsampling rate belonging to a second subsampling interval, subsampling the target image by using a second subsampling algorithm to obtain a subsampled image from the target image;
wherein, the second subsampling interval is larger than the first subsampling interval; the performance overhead of the second subsampling algorithm is larger than the performance overhead of the first subsampling algorithm; in response to the subsampling rates being the same, the image quality of the subsampled image obtained by the second subsampling algorithm is better than the image quality of the subsampled image obtained by the first subsampling algorithm.

10. (canceled)

11. The electronic device of claim 8, wherein,
the subsampling the target image by using a first subsampling algorithm to obtain a subsampled image from the target image, comprises: subsampling the target image using a linear interpolation algorithm to obtain a color value of each sampling point; generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points.

12. The electronic device of claim 8, wherein,
the subsampling the target image by using a first subsampling algorithm to obtain a subsampled image from the target image, comprises: subsampling the target image using a linear interpolation algorithm to obtain a color value of each sampling point; generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

13. The electronic device of claim 8, wherein,
the subsampling the target image by using a first subsampling algorithm to obtain a subsampled image from the target image, comprises: rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

14. The electronic device of claim 11, wherein,
the processor is further configured to, when executing the computer program, enable the electronic device, after generating a subsampled image from the target image based on the color values of sampling points, to implement:
calculating a first calculated value for each pixel in the subsampled image, wherein the first calculated value for any pixel is an average value of color values of preset neighborhood pixels of the pixel;
calculating a second calculated value for each pixel in the subsampled image, wherein the second calculated value for any pixel is a difference between the color value of the pixel and the first calculated value for the pixel;
calculating a third calculated value for each pixel in the subsampled image, wherein the third calculated value for any pixel is a product of the second calculated value for the pixel and a sharpening coefficient; and
calculating a sharpened color value corresponding to each pixel in the subsampled image, wherein the sharpened color value corresponding to any pixel is the sum of the color value of the pixel and the third calculated value for the pixel.

15. The electronic device of claim 14, wherein, the processor is configured to, when executing the computer program, enable the electronic device to implement:
in response to the sharpened color value corresponding to the first pixel in the subsampled image being greater than a maximum color value of a color space to which the subsampled image belongs, setting the sharpened color value corresponding to the first pixel to the maximum color value;
in response to the sharpened color value corresponding to the second pixel in the subsampled image being less than a minimum color value of the color space to which the subsampled image belongs, setting the sharpened color value corresponding to the second pixel to the minimum color value.

16. The non-transitory computer-readable storage medium of claim 9, wherein,
the subsampling the target image by using a first subsampling algorithm to obtain a subsampled image from the target image, comprises: subsampling the target image using a linear interpolation algorithm to obtain a color value of each sampling point; generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points.

17. The non-transitory computer-readable storage medium of claim 9, wherein,
the subsampling the target image by using a first subsampling algorithm to obtain a subsampled image from the target image, comprises: subsampling the target image using a linear interpolation algorithm to obtain a color value of each sampling point; generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

18. The non-transitory computer-readable storage medium of claim 9, wherein,
the subsampling the target image by using a first subsampling algorithm to obtain a subsampled image from the target image, comprises: rendering image data of the target image into a preset texture object to obtain a target render texture; the size of the preset texture object is the same as the size of the target image; subsampling the target render texture using a regional average interpolation algorithm to obtain a color value of each sampling point; and generating a subsampled image from the target image based on the color values of sampling points;
the subsampling the target image by using a second subsampling algorithm to obtain a subsampled image from the target image, comprises: rendering image data of the target image into a preset texture object to obtain a target render texture; the size of the preset texture object is the same as the size of the target image; subsampling the target render texture using a window function algorithm to obtain a color value of each sampling point; and generating a subsampled image from the target image based on the color values of sampling points.

19. The non-transitory computer-readable storage medium of claim 16, wherein,
the computer program, when executed by a computing device, causes the computing device, after generating a subsampled image from the target image based on the color values of sampling points, to implement:
calculating a first calculated value for each pixel in the subsampled image, wherein the first calculated value for any pixel is an average value of color values of preset neighborhood pixels of the pixel;
calculating a second calculated value for each pixel in the subsampled image, wherein the second calculated value for any pixel is a difference between the color value of the pixel and the first calculated value for the pixel;
calculating a third calculated value for each pixel in the subsampled image, wherein the third calculated value for any pixel is a product of the second calculated value for the pixel and a sharpening coefficient; and
calculating a sharpened color value corresponding to each pixel in the subsampled image, wherein the sharpened color value corresponding to any pixel is the sum of the color value of the pixel and the third calculated value for the pixel.

20. The non-transitory computer-readable storage medium of claim 19, wherein, the computer program, when executed by a computing device, causes the computing device to implement:
in response to the sharpened color value corresponding to the first pixel in the subsampled image being greater than a maximum color value of a color space to which the subsampled image belongs, setting the sharpened color value corresponding to the first pixel to the maximum color value;
in response to the sharpened color value corresponding to the second pixel in the subsampled image being less than a minimum color value of the color space to which the subsampled image belongs, setting the sharpened color value corresponding to the second pixel to the minimum color value.
